(19) United States
(12) Patent Application Publication
(10) Pub. No.: US 2025/0231109 A1
(43) Pub. Date: Jul. 17, 2025

(54) METHOD FOR DETECTING ANALYTES WITH A FLUOROPHORE

(71) Applicant: UNIVERSITY OF UTAH RESEARCH FOUNDATION, Salt Lake City, UT (US)

(72) Inventors: Ling Zang, Salt Lake City, UT (US); Marc D. Porter, Salt Lake City, UT (US); Rana Dalapati, Salt Lake City, UT (US); Soumen Saha, Salt Lake City, UT (US)

(21) Appl. No.: 19/017,166

(22) Filed: Jan. 10, 2025

Related U.S. Application Data
(60) Provisional application No. 63/620,661, filed on Jan. 12, 2024.

(51) Int. Cl. G01N 21/64

(52) U.S. Cl. CPC G01N 21/6428; G01N 21/6458; G01N 2021/6439

(57) ABSTRACT

Described are methods for detecting an analyte in a liquid sample using negligible depletion and a fluorophore adhered to a solid phase extraction membrane.

### CROSS-REFERENCE TO RELATED APPLICATIONS

This application claims priority to U.S. Provisional Patent Application No. 63/620,661, filed on Jan. 12, 2024, which is incorporated by reference herein in its entirety.

### BACKGROUND

Driven by increases in the world's population and industrial manufacturing, the need for simple and easy-to-use tests for the analysis of contaminated water at the point of access continues to be a global imperative. Today's most used approaches to water analysis include a range of hyphenated chromatographic-mass spectrometric techniques, electrochemistry, infrared (IR) and Raman spectrometry (including surface enhanced Raman scattering), and other spectrometric methods. However, the cost, foot-print, power requirement, sample preparation, and processing associated with these technologies limit their deployment beyond the formal laboratory setting. Chemical sensors, such as those comprising a fluorescent molecule, may provide a simple, sensitive, and reliable means to detect a variety of organic and inorganic pollutants in water.

What is needed are fluorometric methods for the detection of analytes.

### SUMMARY

One embodiment described herein is a method for detecting an analyte in a liquid sample using a solid-phase extraction device that includes a solid-phase extraction membrane and a fluorophore adhered to the membrane, the method comprising: measuring fluorescence intensity of a surface on the solid-phase extraction membrane at an emission wavelength in the absence of the analyte; flowing the sample over the solid-phase extraction membrane; obtaining a negligible depletion condition for any analyte in the sample; measuring fluorescence intensity of the surface at an emission wavelength while the negligible depletion condition exists; and determining whether the analyte is present in the sample based on a change in the fluorescence.

In one aspect, the fluorophore comprises a perylene, anthracene, oxazine, cyanine, pyrromethane, pyrene, rhodamine, pyyromethane difluoride, pyronine, or pentamethine. In another aspect, the fluorophore is non-covalently adhered to the solid-phase extraction membrane. In another aspect, the fluorophore is covalently adhered to the solid-phase extraction membrane. In another aspect, the analyte comprises an amine or an aniline. In another aspect, the analyte is an aminoglycoside, a peptide, a derivative thereof, or a metabolite thereof. In another aspect, the fluorophore is a perylene diimide fluorophore and the analyte is a compound comprising an amine. In another aspect, the perylene diimide fluorophore is N,N′-di(nonyldecyl)-perylene-3,4,9,10-tetracarboxylic diimide or a derivative thereof. In another aspect, the solid-phase extraction membrane is fabricated from a polymer, a copolymer, a resin, a filter, silica, or a combination thereof. In another aspect, the solid-phase extraction membrane is a polymer. In another aspect, the polymer comprises polytetrafluoroethylene. In another aspect, the solid-phase extraction membrane comprises silica modified with C18. In another aspect, the solid-phase extraction membrane has pores with diameters ranging from 0.1-10 μm. In another aspect, fluorescence is measured directly on the solid-phase extraction membrane. In another aspect, wherein fluorescence is measured after eluting the fluorophore from the solid phase extraction membrane. In another aspect, the method further comprises calculating the concentration of the analyte in the sample using a standard curve. In another aspect, the solid phase extraction membrane is incorporated into a disk. In another aspect, the disk has as diameter of 5 mm to 100 mm. In another aspect, measuring is performed with a fluorimeter or a fluorescence microscope.

### DESCRIPTION OF DRAWINGS

FIG. 1 is a schematic diagram showing the procedure for fabricating a fluorescent Solid Phased Extraction (“SPE”) disk by running 10 mL of a 10 μM perylene diimide (“PDI”) based fluorophore solution in propanol through the disk using vacuum filtration.

FIG. 2 is a schematic diagram showing the use of an exemplary fluorescence solid-phase extraction (“F-SPE”) membrane coated with a C9/9-PDI fluorophore (N,N′-di(nonyldecyl)-perylene-3,4,9,10-tetracarboxylic diimide) in a vacuum filtration system to detect analine and/or kanamycin sulfate. Specifically, the fluorescence of the fluorophore is quenched via photoinduced electron transfer (PET) between the amine in aniline and/or kanamycin sulfate and the fluorophore.

FIG. 3 is a schematic diagram showing an exemplary fluorescence measurement system that includes a portable fluorometer equipped with optic fibers for excitation and emission data collection.

FIG. 4A-C show various fluorescence spectra associated with the C9/9-PDI fluorophore. FIG. 4A shows the fluorescence emission spectra measured for a 10 μM solution of C9/9-PDI in propanol with λₑₓ=490 nm in a quartz cuvette. FIG. 4B shows the fluorescence emission spectra of an Empore™ disk coated with C9/9-PDI after it has been washed with 10 mL of deionized water 1-8 separate times, demonstrating that the C9/9-PDI fluorophore stays tightly adhered to the Empore™ disk despite repeated washes with deionized water. FIG. 4C shows the fluorescence spectra of five different Empore™ disk coated with C9/9-PDI, demonstrating the consistency in the coating process.

FIG. 5 shows the fluorescence intensities measured for C9/9-PDI coated Empore™ disks after filtering with varying volumes of 1 μM and 10 μM solutions of aniline in water.

FIG. 6 shows the fluorescence intensities measured for the C9/9-PDI coated Empore™ disk after filtering with varying volumes of 1 μM and 10 μM solutions of kanamycin in water.

FIGS. 7A and 7B demonstrate the use of Empore™ disks coated with C9/9-PDI fluorophore for detection and quantification of aniline in DI water. FIG. 7A shows the fluorescence spectra of an Empore™ disk coated with C9/9-PDI fluorophore measured before (free) and after passing 2 μM, 6 μM, and 10 μM solutions of aniline through the disk. FIG. 7B is a plot showing the fluorescence quenching efficiency of aniline as a function of the concentration of aniline.

FIG. 8A-B demonstrate the use of Empore™ disks coated with C9/9-PDI fluorophore for detection and quantification of aniline in tap water. FIG. 7A show the fluorescence spectra of the Empore™ disk coated with C9/9-PDI measured before and after passage of 60 mL of aniline solution in tap water containing varying concentrations of aniline, 0, 2, 4, 6, 8 and 10 μM. FIG. 7B is a plot showing the fluorescence quenching efficiency as a function of the concentration of aniline, and all the data points can be fitted well with Eq. 3. The sample volume used, 60 mL, is above the ND volume (40 mL) determined for aniline with the Empore™ disk.

FIGS. 9A and 9B demonstrate the use of Empore™ disks coated with C9/9-PDI fluorophore for detection and quantification of kanamycin. FIG. 9A shows the fluorescence spectra of an Empore™ disk coated with C9/9-PDI fluorophore measured before (free) and after passing 2 μM and 20 μM solutions of kanamycin through the disk. FIG. 9B is a plot showing the quenching efficiency of kanamycin as a function of the concentration of kanamycin.

FIG. 10 is a bar chart showing the efficiency of various analytes to quench the fluorescence of Empore™ disks coated with a C9/9-PDI fluorophore. The bar chart compares the fluorescent quenching efficiency of 5 amines relative to 16 other chemicals commonly found in environmental water samples. All of the chemicals were tested under the same concentration (5 mM).

### DETAILED DESCRIPTION

Unless otherwise defined, all technical and scientific terms used herein have the same meaning as commonly understood by one of ordinary skill in the art. For example, any nomenclatures used in connection with, and techniques of biochemistry, molecular biology, immunology, microbiology, genetics, cell and tissue culture, and protein and nucleic acid chemistry described herein are well known and commonly used in the art. In case of conflict, the present disclosure, including definitions, will control. Exemplary methods and materials are described below, although methods and materials similar or equivalent to those described herein can be used in practice or testing of the embodiments and aspects described herein.

As used herein, the terms “amino acid,” “nucleotide,” “polynucleotide,” “vector,” “polypeptide,” and “protein” have their common meanings as would be understood by a biochemist of ordinary skill in the art. Standard single letter nucleotides (A, C, G, T, U) and standard single letter amino acids (A, C, D, E, F, G, H, I, K, L, M, N, P, Q, R, S, T, V, W, or Y) are used herein.

As used herein, terms such as “include,” “including,” “contain,” “containing,” “having,” and the like mean “comprising.” The present disclosure also contemplates other embodiments “comprising,” “consisting essentially of,” and “consisting of” the embodiments or elements presented herein, whether explicitly set forth or not. As used herein, “comprising,” is an “open-ended” term that does not exclude additional, unrecited elements or method steps. As used herein, “consisting essentially of” limits the scope of a claim to the specified materials or steps and those that do not materially affect the basic and novel characteristics of the claimed invention.

As used herein, “consisting of” excludes any element, step, or ingredient not specified in the claim.

As used herein, the term “a,” “an,” “the” and similar terms used in the context of the disclosure (especially in the context of the claims) are to be construed to cover both the singular and plural unless otherwise indicated herein or clearly contradicted by the context. In addition, “a,” “an,” or “the” means “one or more” unless otherwise specified.

As used herein, the term “or” can be conjunctive or disjunctive.

As used herein, the term “and/or” refers to both the conjunctive and disjunctive.

As used herein, the term “substantially” means to a great or significant extent, but not completely.

As used herein, the term “about” or “approximately” as applied to one or more values of interest, refers to a value that is similar to a stated reference value, or within an acceptable error range for the particular value as determined by one of ordinary skill in the art, which will depend in part on how the value is measured or determined, such as the limitations of the measurement system. In one aspect, the term “about” refers to any values, including both integers and fractional components that are within a variation of up to ±10% of the value modified by the term “about.” Alternatively, “about” can mean within 3 or more standard deviations, per the practice in the art. Alternatively, such as with respect to biological systems or processes, the term “about” can mean within an order of magnitude, in some embodiments within 5-fold, and in some embodiments within 2-fold, of a value. As used herein, the symbol “˜” means “about” or “approximately.”

All ranges disclosed herein include both end points as discrete values as well as all integers and fractions specified within the range. For example, a range of 0.1-2.0 includes 0.1, 0.2, 0.3, 0.4 . . . 2.0. If the end points are modified by the term “about,” the range specified is expanded by a variation of up to ±10% of any value within the range or within 3 or more standard deviations, including the end points, or as described above in the definition of “about.”

As used herein, the terms “room temperature,” “RT,” or “ambient temperature” refer to the typical temperature in an indoor laboratory setting. In one aspect, the laboratory setting is climate controlled to maintain the temperature at a substantially uniform temperature or with a specific range of temperatures. In one aspect, “room temperature” refers a temperature of about 15-30° C., including all integers and endpoints within the specified range. In another aspect, “room temperature” refers a temperature of about 15-30° C.; about 20-30° C.; about 22-30° C.; about 25-30° C.; about 27-30° C.; about 15-22° C.; about 15-25° C.; about 15-27° C.; about 20-22° C.; about 20-25° C.; about 20-27° C.; about 22-25° C.; about 22-27° C.; about 25-27° C.; about 15° C.±10%; about 20° C.±10%; about 22° C.±10%; about 25° C.±10%; about 27° C.±10%; ˜20° C., ˜22° C., ˜25° C., or ˜27° C., at standard atmospheric pressure.

As used herein, the terms “control,” or “reference” are used herein interchangeably. A “reference” or “control” level may be a predetermined value or range, which is employed as a baseline or benchmark against which to assess a measured result. “Control” also refers to control experiments or control cells.

The term “adhered,” as used herein, means that an object is associated with another object either through permanent or transient interactions.

It will be understood that when a feature, such as a layer, region or substrate, is referred to as being “on” another feature or element, it can be directly on the other feature or element or intervening features and/or elements may also be present. In contrast, when an element is referred to as being “directly on” another feature or element, there are no intervening elements present.

Definitions of specific functional groups and chemical terms are described in more detail herein. The chemical elements are identified in accordance with the Periodic Table of the Elements, CAS version, Handbook of Chemistry and Physics, 75^{th} ed., inside cover, and specific functional groups are generally defined as described therein. Additionally, general principles of organic chemistry, as well as specific functional moieties and reactivity, are described in Thomas Sorrell, Organic Chemistry, University Science Books, Sausalito, 1999; Smith and March, March's Advanced Organic Chemistry, 5^{th} ed, John Wiley & Sons, Inc., New York, 2001; Larock, Comprehensive Organic Transformations, VCH Publishers, Inc., New York, 1989; and Carruthers, Some Modern Methods of Organic Synthesis, 3^{rd} ed, Cambridge University Press, Cambridge, 1987.

As used herein, the term “alkyl” refers to a straight or branched hydrocarbon radical having from 1 to 12 (e.g., C₁-C₁₂) carbon atoms and includes, for example, methyl, ethyl, n-propyl, isopropyl, n-butyl, sec-butyl, isobutyl, tert-butyl, n-pentyl, iso-pentyl, n-hexyl, and the like.

As used herein, the term “alkenyl” refers to straight and branched hydrocarbon radicals having from 2 to 12 carbon atoms (e.g., C₂-C₁₂) and at least one double bond and includes, but is not limited to, ethenyl, 3-buten-1-yl, 2-ethenylbutyl, 3-hexen-1-yl, and the like. The term “alkenyl” includes cycloalkenyl, and heteroalkenyl in which 1 to 3 heteroatoms selected from O, S, N, or substituted nitrogen may replace carbon atoms.

As used herein, the term “alkynyl” refers to straight and branched hydrocarbon radicals having from 2 to 12 carbon atoms (e.g., C₂-C₁₂) and at least one triple bond and includes, but is not limited to, ethynyl, 3-butyn-1-yl, propynyl, 2-butyn-1-yl, 3-pentyn-1-yl, and the like.

As used herein, the term “cycloalkyl” refers to a monocyclic or polycyclic hydrocarbyl group having from 3 to 8 carbon atoms (e.g., C₃-C₈), for instance, cyclopropyl, cycloheptyl, cyclooctyl, cyclodecyl, cyclobutyl, adamantyl, norpinanyl, decalinyl, norbornyl, cyclohexyl, and cyclopentyl. Such groups can be substituted with groups such as hydroxy, keto, amino, alkyl, and dialkylamino, and the like. Also included are rings in which 1 to 3 heteroatoms replace carbons. Such groups are termed “heterocyclyl,” which means a cycloalkyl group also bearing at least one heteroatom selected from O, S, N, or substituted nitrogen. Examples of such groups include, but are not limited to, oxiranyl, pyrrolidinyl, piperidyl, tetrahydropyran, and morpholine.

As used herein, the term “alkoxy” refers to a straight or branched chain alkyl groups having 1-10 carbon atoms (e.g., C₂-C₁₀) and linked through oxygen. Examples of such groups include, but are not limited to, methoxy, ethoxy, propoxy, isopropoxy, n-butoxy, sec-butoxy, tert-butoxy, pentoxy, 2-pentyloxy, isopentoxy, neopentoxy, hexoxy, 2-hexoxy, 3-hexoxy, and 3-methylpentoxy. In addition, alkoxy refers to polyethers such as —O— (CH₂)₂O—CH₃, and the like.

The alkyl, alkenyl, alkoxy, and alkynyl groups described herein are optionally substituted (i.e., may be substituted, but are not necessarily substituted), preferably by 1 to 3 groups selected from NR₄R₅, phenyl, substituted phenyl, thio C₁-C₆ alkyl, C₁-C₆ alkoxy, hydroxy, carboxy, C₁-C₆ alkoxycarbonyl, halo, nitrile, cycloalkyl, and a 5- or 6-membered carbocyclic ring or heterocyclic ring having 1 or 2 heteroatoms selected from nitrogen, substituted nitrogen, oxygen, and sulfur. “Substituted nitrogen” means nitrogen bearing C₁-C₆ alkyl or (CH₂)ₚPh where p is 1, 2, or 3. Perhalo and polyhalo substitution is also included.

Examples of substituted alkyl groups include, but are not limited to, 2-aminoethyl, 2-hydroxyethyl, pentachloroethyl, trifluoromethyl, 2-diethylaminoethyl, 2-dimethylaminopropyl, ethoxycarbonylmethyl, 3-phenylbutyl, methanylsulfanylmethyl, methoxymethyl, 3-hydroxypentyl, 2-carboxybutyl, 4-chlorobutyl, 3-cyclopropylpropyl, pentafluoroethyl, 3-morpholinopropyl, piperazinylmethyl, and 2-(4-methylpiperazinyl)ethyl.

Examples of substituted alkynyl groups include, but are not limited to, 2-methoxyethynyl, 2-ethylsulfanylethynyl, 4-(1-piperazinyl)-3-(butynyl), 3-phenyl-5-hexynyl, 3-diethylamino-3-butynyl, 4-chloro-3-butynyl, 4-cyclobutyl-4-hexenyl, and the like.

Typical substituted alkoxy groups include aminomethoxy, trifluoromethoxy, 2-diethylaminoethoxy, 2-ethoxycarbonylethoxy, 3-hydroxypropoxy, 6-carboxhexyloxy, and the like.

Further, examples of substituted alkyl, alkenyl, and alkynyl groups include, but are not limited to, dimethylaminomethyl, carboxymethyl, 4-dimethylamino-3-buten-1-yl, 5-ethylmethylamino-3-pentyn-1-yl, 4-morpholinobutyl, 4-tetrahydropyrinidylbutyl, 3-imidazolidin-1-ylpropyl, 4-tetrahydrothiazol-3-yl-butyl, phenylmethyl, 3-chlorophenylmethyl, and the like.

As used herein, the term “anion” means a negatively charged species such as chloride, bromide, trifluoroacetate, or triethylammonium. The term “cation” refers to a positively charged species, such as sodium, potassium, or ammonium.

As used herein, the term “acyl” refers to alkyl or aryl (Ar) group having from 1-10 carbon atoms bonded through a carbonyl group, i.e., R—C(O)—. For example, acyl includes, but is not limited to, a C₁-C₆ alkanoyl, including substituted alkanoyl, wherein the alkyl portion can be substituted by an amine, amide, carboxylic, or heterocyclic group. Typical acyl groups include acetyl, benzoyl, and the like.

As used herein, the term “aryl” refers to an aromatic monocyclic hydrocarbon ring system or a polycyclic ring system where at least one of the rings in the ring system is an aromatic hydrocarbon ring and any other aromatic rings in the ring system include only hydrocarbons. In some embodiments, a monocyclic aryl group can have from 6 to 14 carbon atoms and a polycyclic aryl group can have from 8 to 14 carbon atoms (e.g., C₈-C₁₄). The aryl group can be covalently attached to the defined chemical structure at any carbon atom(s) that result in a stable structure. In some embodiments, an aryl group can have only aromatic carbocyclic rings, e.g., phenyl, 1-naphthyl, 2-naphthyl, anthracenyl, phenanthrenyl groups, and the like. In other embodiments, an aryl group can be a polycyclic ring system in which at least one aromatic carbocyclic ring is fused (i.e., having a bond in common with) to one or more cycloalkyl or cycloheteroalkyl rings. Examples of such aryl groups include, among others, benzo derivatives of cyclopentane (i.e., an indanyl group, which is a 5,6-bicyclic cycloalkyl/aromatic ring system), cyclohexane (i.e., a tetrahydronaphthyl group, which is a 6,6-bicyclic cycloalkyl/aromatic ring system), imidazoline (i.e., a benzimidazolinyl group, which is a 5,6-bicyclic cycloheteroalkyl/aromatic ring system), and pyran (i.e., a chromenyl group, which is a 6,6-bicyclic cycloheteroalkyl/aromatic ring system). Other examples of aryl groups include benzodioxanyl, benzodioxolyl, chromanyl, indolinyl groups, and the like.

As used herein, the terms “halogen” or “halo” refer to fluorine, bromine, chlorine, or iodine.

As used herein, the term “haloalkyl” refers to an alkyl group having one or more halogen substituents. In some embodiments, a haloalkyl group can have 1 to 10 carbon atoms (e.g., C₁-C₈). Examples of haloalkyl groups include CF₃, C₂F₅, CHF₂, CH₂F, CC₃, CHCI₂, CH₂Cl, C₂Cl₅, and the like. Perhaloalkyl groups, i.e., alkyl groups wherein all the hydrogen atoms are replaced with halogen atoms (e.g., CF₃ and C₂F₅), are included within the definition of “haloalkyl.” For example, a C₁₋₁₀ haloalkyl group can have the formula —CᵢH₂ᵢ₊₁-jXⱼ, wherein X is F, Cl, Br, or I, i is an integer in the range of 1 to 10, and j is an integer in the range of 0 to 21, provided that j is less than or equal to 2i+1.

As used herein, the term “heteroaryl” refers to an aromatic monocyclic ring system containing at least one ring heteroatom selected from O, N, and S or a polycyclic ring system where at least one of the rings in the ring system is aromatic and contains at least one ring heteroatom. A heteroaryl group can have from 5 to 14 ring atoms (e.g., C₅-C₁₄), and contains 1-6 ring heteroatoms (e.g., N, O, S, P, or the like). In some embodiments, heteroaryl groups can include monocyclic heteroaryl rings fused to one or more aromatic carbocyclic rings, non-aromatic carbocyclic rings, or non-aromatic cycloheteroalkyl rings. The heteroaryl group can be covalently attached to the defined chemical structure at any heteroatom or carbon atom that results in a stable structure. Generally, heteroaryl rings do not contain O—O, S—S, or S—O bonds. However, one or more N or S atoms in a heteroaryl group can be oxidized (e.g., pyridine N-oxide, thiophene S-oxide, thiophene S,S-dioxide). Examples of such heteroaryl rings include pyrrolyl, furyl, thienyl, pyridyl, pyrimidyl, pyridazinyl, pyrazinyl, triazolyl, tetrazolyl, pyrazolyl, imidazolyl, isothiazolyl, thiazolyl, thiadiazolyl, isoxazolyl, oxazolyl, oxadiazolyl, indolyl, isoindolyl, benzofuryl, benzothienyl, quinolyl, 2-methylquinolyl, isoquinolyl, quinoxalyl, quinazolyl, benzotriazolyl, benzimidazolyl, benzothiazolyl, benzisothiazolyl, benzisoxazolyl, benzoxadiazolyl, benzoxazolyl, cinnolinyl, 1H-indazolyl, 2H-indazolyl, indolizinyl, isobenzofuyl, naphthyridinyl, phthalazinyl, pteridinyl, purinyl, oxazolopyridinyl, thiazolopyridinyl, imidazopyridinyl, furopyridinyl, thienopyridinyl, pyridopyrimidinyl, pyridopyrazinyl, pyridopyrdazinyl, thienothiazolyl, thienooxazolyl, thienoimidazolyl groups, and the like. Further examples of heteroaryl groups include 4,5,6,7-tetrahydroindolyl, tetrahydroquinolinyl, benzothienopyridinyl, benzofuropyridinyl groups, and the like.

As used herein, the term “lower alkenyl” refers to alkenyl groups which contains 2 to 6 carbon atoms (e.g., C₂-C₆). An alkenyl group is a hydrocarbyl group containing at least one carbon-carbon double bond. As defined herein, it may be unsubstituted or substituted with the substituents described herein. The carbon-carbon double bonds may be between any two carbon atoms of the alkenyl group. It is preferred that it contains 1 or 2 carbon-carbon double bonds and more preferably one carbon-carbon double bond. The alkenyl group may be straight chained or branched. Examples include but are not limited to ethenyl, 1-propenyl, 2-propenyl, 1-butenyl, 2-butenyl, 2-methyl-1-propenyl, 1,3-butadienyl, and the like.

As used herein, the term “lower alkynyl” refers to an alkynyl group containing 2-6 carbon atoms (e.g., C₂-C₆). An alkynyl group is a hydrocarbyl group containing at least one carbon-carbon triple bond. The carbon-carbon triple bond may be between any two-carbon atom of the alkynyl group. In an embodiment, the alkynyl group contains 1 or 2 carbon-carbon triple bonds and more preferably one carbon-carbon triple bond. The alkynyl group may be straight chained or branched. Examples include but are not limited to ethynyl, 1-propynyl, 2-propynyl, 1-butynyl, 2-butynyl and the like.

As used herein, the term “carbalkoxy” refers to an alkoxycarbonyl group, where the attachment to the main chain is through the carbonyl group, e.g., —C(O)—. Examples include but are not limited to methoxy carbonyl, ethoxy carbonyl, and the like.

As used herein, the term “oxo” refers to a double-bonded oxygen (i.e., ═O). It is also to be understood that the terminology C(O) refers to a —C═O group, whether it be ketone, aldehyde or acid or acid derivative. Similarly, S(O) refers to a —S═O group.

As used herein, the term “cycloalkyl” refers to a non-aromatic carbocyclic group including cyclized alkyl, alkenyl, and alkynyl groups. A cycloalkyl group can be monocyclic (e.g., cyclohexyl) or polycyclic (e.g., containing fused, bridged, and/or spiro ring systems), wherein the carbon atoms are located inside or outside of the ring system. A cycloalkyl group can have from 3 to 14 ring atoms (e.g., from 3 to 8 carbon atoms for a monocyclic cycloalkyl group and from 7 to 14 carbon atoms for a polycyclic cycloalkyl group). Any suitable ring position of the cycloalkyl group can be covalently linked to the defined chemical structure. Examples of cycloalkyl groups include cyclopropyl, cyclobutyl, cyclopentyl, cyclohexyl, cycloheptyl, cyclopentenyl, cyclohexenyl, cyclohexadienyl, cycloheptatrienyl, norbornyl, norpinyl, norcaryl, adamantyl, and spiro[4.5]decanyl groups, as well as their homologs, isomers, and the like.

As used herein, the term “heteroatom” refers to an atom of any element other than carbon or hydrogen and includes, for example, nitrogen, oxygen, sulfur, phosphorus, and selenium.

As used herein, the term “cycloheteroalkyl” refers to a non-aromatic cycloalkyl group that contains at least one (e.g., one, two, three, four, or five) ring heteroatom selected from O, N, and S, and optionally contains one or more (e.g., one, two, or three) double or triple bonds. A cycloheteroalkyl group can have from 3 to 14 ring atoms and contains from 1 to 5 ring heteroatoms (e.g., from 3-6 ring atoms for a monocyclic cycloheteroalkyl group and from 7 to 14 ring atoms for a polycyclic cycloheteroalkyl group). The cycloheteroalkyl group can be covalently attached to the defined chemical structure at any heteroatom(s) or carbon atom(s) that results in a stable structure. One or more N or S atoms in a cycloheteroalkyl ring may be oxidized (e.g., morpholine N-oxide, thiomorpholine S-oxide, thiomorpholine S,S-dioxide). Cycloheteroalkyl groups can also contain one or more oxo groups, such as phthalimidyl, piperidinyl, oxazolidinoxyl, 2,4(1H,3H)-dioxo-pyrimidinyl, pyridin-2(1H)-onyl, and the like. Examples of cycloheteroalkyl groups include, among others, morpholinyl, thiomorpholinyl, pyranyl, imidazolidinyl, imidazolinyl, oxazolidinyl, pyrazolidinyl, pyrazolinyl, pyrrolidinyl, pyrrolinyl, tetrahydrofuranyl, tetrahydrothienyl, piperidinyl, piperazinyl, azetidine, and the like.

### Fluorescence and Fluorescence Quenching

“Fluorescence” as used herein is a cyclical process where a luminescence is generated by certain molecules in which the molecular absorption of a photon triggers the emission of another photon with a longer wavelength. Certain molecules are capable of being excited, via absorption of light energy, to a higher energy state, also called an excited state. The energy of this short-lived excited state decays (or decreases) resulting in the emission of light energy. The emission of light via this process is “fluorescence.” Molecules that emit light in this manner are said to “fluoresce” and are generally referred to as “fluorophores” or “fluorescent dyes.”

A “fluorophore” or “fluorescent dye,” as used herein, is a molecule that is capable of fluorescing. In its ground state, the fluorophore molecule is in a relatively low-energy, stable configuration, and it does not fluoresce. When light from an external source of one or more particular wavelengths contacts a fluorophore, the fluorophore can absorb the light energy. If the fluorophore absorbs sufficient energy, the fluorophore is excited to an excited state (high energy); this process is known as excitation. There may be multiple excited states or high energy levels that a fluorophore can attain, depending on the wavelength and energy of the external light source. Since a fluorophore is unstable at high-energy configurations, it eventually decays to the lowest-energy excited state, which is semi-stable. The excited lifetime (the length of time that a fluorophore is an excited state) is very short; the fluorophore the decays from the semi-stable excited state back to the ground state, and at least a portion of the excess energy released by this decay may be emitted as light. The emitted light is of a lower energy, and a longer wavelength, than the absorbed light, and thus the color of the light that is emitted is different from the color of the light that has been absorbed. Upon reaching the ground state, a fluorophore can again absorb light energy to enter an excited state.

A fluorophore or fluorescent dye absorbs light over a range of wavelengths and every dye has a characteristic range of excitation wavelengths. This range of excitation wavelengths is referred to as the fluorescence “excitation spectrum” and reflects the range of possible excited states that the dye can achieve. Certain wavelengths within this range are more effective for excitation than other wavelengths. A fluorophore is excited most efficiently by light of a particular wavelength. This wavelength is the excitation maximum for the fluorophore. As used herein “excitation maximum” refers to the specific wavelength for each fluorescent dye that most effectively induces fluorescence. Less efficient excitation can occur at wavelengths near the excitation maximum; however, the intensity of the emitted fluorescence is reduced. Although illumination at the excitation maximum of the fluorophore produces the greatest fluorescence output, illumination at lower or higher wavelengths affects only the intensity of the emitted light; the range and overall shape of the emission profile are unchanged.

As used herein, “excitation” refers to the process where a photon of energy supplied by an external source, such as a laser or a lamp, is absorbed by the fluorophore creating an excited electronic singlet state (S₁′) from the S₀ ground state. The excited state exists for a finite time during which the fluorophore undergoes conformational changes and is also subject to a multitude of possible interactions with its molecular environment. These processes have two important consequences. One of these consequences is that the energy of S₁′ is partially dissipated, yielding a relaxed singlet excited state (S₁) from which fluorescence emission originates.

Molecules in an excited state (S₁′) can relax by various competing pathways. They can undergo “non-radiative relaxation” in which the excitation energy is dissipated as heat (vibrations) to the solvent. Excited organic molecules can also relax via conversion to a triplet state which may subsequently relax via phosphorescence or by a secondary non-radiative relaxation step. The term “relax” as used herein refers to the energy loss of an excited molecule. Not all the molecules initially excited by absorption return to the ground state (S₀) by fluorescence emission. Relaxation of an S₁′ state can also occur through interaction with a second molecule through fluorescence quenching. Other processes, such as, but not limited to, collisional quenching or fluorescent resonance energy transfer (FRET), may also depopulate S₁.

FRET is now widely known in the art. FRET is a radiationless process in which energy is transferred from an excited donor molecule to an acceptor molecule. Radiationless energy transfer is the quantum-mechanical process by which the energy of the excited state of one fluorophore is transferred without actual photon emission to a second fluorophore or molecule.

The quantum physical principles are reviewed in Jovin and Jovin, 1989, Cell Structure and Function by Microspectrofluorometry, eds. E. Kohen and J. G. Hirschberg, Academic Press incorporated herein by reference for the teachings. Briefly, a fluorophore absorbs light energy at a characteristic wavelength. The first fluorophore is generally termed the donor (“D”) and may have an excited state of higher energy than that of the second fluorophore, termed the acceptor (“A”).

An essential feature of FRET is that the emission spectrum of the donor overlap with the excitation spectrum of the acceptor, and that the donor and acceptor be sufficiently close. In addition, the distance between “D” and “A” must be sufficiently small to allow the radiationless transfer of energy between the fluorophores. Because the rate of energy transfer is inversely proportional to the sixth power of the distance between the donor and acceptor, the energy transfer efficiency is extremely sensitive to distance changes. Energy transfer is said to occur with detectable efficiency in the 1-10 nm distance range but is typically 4-6 nm for optimal results. The distance range over which radiationless energy transfer is effective depends on many other factors as well, including the fluorescence quantum efficiency of the donor, the extinction coefficient of the acceptor, the degree of overlap of their respective spectra, the refractive index of the medium, and the relative orientation of the transition moments of the two fluorophores.

As used herein, the term “quencher” means a substance, which reduces or quenches the emission of fluorescence from a fluorophore. As used herein, “fluorescence quenching” may be achieved by any mechanism, typically by FRET between a fluorophore and a non-fluorescent quenching moiety or by collisional (i.e., contact) quenching.

Fluorophore molecules, when excited, emit over a range of wavelengths. This range of wavelengths is referred to as the fluorescence “emission spectrum.” There is a spectrum of energy changes associated with these emission events. The emission maximum is the wavelength where the population of molecules fluoresces most intensely. The emission maximum for a given fluorophore is always at a longer wavelength (lower energy) than the excitation maximum. This difference between the excitation and emission maxima is called the Stokes shift. The magnitude of the Stokes shift is determined by the electronic structure of the fluorophore and is characteristic of the fluorophore molecule. The Stokes shift occurs because some of the energy of the excited fluorophore is lost through molecular vibrations that occur during the brief lifetime of the molecule's excited state, which is dissipated as heat to surrounding solvent molecules as they collide with the excited fluorophore. Remaining energy that is emitted as light fluorescence is thus less than the amount of energy required for excitation.

Fluorescence requires a source of excitation energy. There are many light source options for fluorescence. Selecting the appropriate light source, and filters for both excitation and emission, can increase the sensitivity of signal detection.

Several types of light sources are used to excite fluorescent dyes. The most common sources used are broadband sources, such as, for example, mercury-arc and tungsten-halogen lamps. These lamps produce white light that has peaks of varying intensity across the spectrum. When using broadband white light sources, it is necessary to filter the desired wavelengths needed for excitation; this is most often done using optical filters. Optical filters selectively allow light of certain wavelengths to pass while blocking out undesirable wavelengths. A bandpass excitation filter transmits a narrow range of wavelengths and may be used for selective excitation.

Laser excitation sources provide wavelength peaks that are well-defined, selective, and of high intensity allowing more selective illumination of the sample. The best performance is achieved when the dye's peak excitation wavelength is close to the wavelength of the laser. Several lasers commonly used include, for example, the compact violet 405 nm laser, 488 nm blue-green argon-ion laser, 543 nm helium-neon green laser, and 633 nm helium-neon red laser. Mixed-gas lasers such as, for example, the krypton-argon laser, can output multiple laser lines which may require optical filters to achieve selective excitation. High-output light-emitting diodes (LEDs) provide selective wavelengths, low cost and energy consumption, and long lifetime. Single-color LEDs are ideal for low-cost instrumentation where they can be combined with simple long-pass filters that block the LED excitation and allows the transmission of the dye signal. However, the range of wavelengths emitted from each LED is still relatively broad and may also require the use of a filter to narrow the bandwidth.

Filters are important for selecting excitation wavelengths and for isolating the fluorescence emission emanating from the dye of interest. Stray light arising from sources other than the emitting fluorophores (for example, from the excitation source) interferes with the detection of the fluorescence emission. Stray light therefore must be contained to ensure only the fluorescence of the sample registers with the instrument's light-sensitive detectors. When a single fluorophore is used, a long pass emission filter which selectively blocks out the excitation light to reduce background noise may be used to maximize the signal collected. If multiple fluorophores are used in the sample, a band pass emission filter can be used to isolate the emission from each dye.

### Fluorophores

Any fluorophore may be used with the methods described herein. Non-limiting examples of fluorophores include rhodamine-based molecules, squarylium-based molecules, cyanine-based molecules, aromatic ring-based molecules, oxazine-based molecules, carbopyronine-based molecules and pyrromethene-based molecules. In some embodiments, the fluorophores may be selected from, for example, Alexa Fluor®-based molecules (registered trademark, manufactured by Invitrogen), BODIPY®-based molecules (registered trademark, manufactured by Invitrogen), Cy™-based molecules (registered trademark, manufactured by GE Healthcare), DY™-based molecules (registered trademark, Dyomics GmbH), HiLyte™-based molecules (registered trademark, manufactured by AnaSpec Inc.), DyLight®-based molecules (registered trademark, manufactured by Thermo Fisher Scientific K.K.), ATTO™-based dmolecules (registered trademark, manufactured by ATTO-TEC GmbH) and MFP™-based molecules (registered trademark, manufactured by Mobitec Co., Ltd.), among other well known fluorophores. The generic names of these molecules are designated based on the main structure (skeleton) or the registered trademark of the respective compounds. Those of ordinary skill in the art can properly understand the scope of fluorophores belonging to the respective generic names without having to bear undue experimentation.

Specific examples of rhodamine-based fluorophores may include, but are not limited to, 5-carboxy-rhodamine, 6-carboxy-rhodamine, 5,6-dicarboxy-rhodamine, rhodamine 6G, tetramethyl rhodamine, X-rhodamine, Texas Red, Spectrum Red and LD700 PERCHLORATE.

Some specific examples of squarylium-based fluorophores include, but are not limited to, SRfluor 680-carboxylate, 1,3-Bis[4-(dimethylamino)-2-hydroxyphenyl]-2,4-dihydroxycyclobutenediylium dihydroxide, bis, 1,3-bis[4-(dimethylamino)phenyl]-2,4-dihydroxycyclobutenediylium dihydroxide, bis,2-(4-(diethylamino)-2-hydroxyphenyl)-4-(4-(diethyliminio)-2-hydroxycyclohexa-2,5-dienylidene)-3-oxocyclobut-1-enolate, 2-(4-(dibutylamino)-2-hydroxyphenyl)-4-(4-(dibutyliminio)-2-hydroxycyclohexa-2,5-dienylidene)-3-oxocyclobut-1-enolate and 2-(8-hydroxy-1,1,7,7-tetramethyl-1,2,3,5,6,7-hexahydropyrido[3,2,1-ij]quinolin-9-yl)-4-(8-hydroxy-1,1,7,7-tetramethyl-2,3,6,7-tetrahydro-1H-pyrido[3,2,1-ij]quinolinium-9(5H)-ylidene)-3-oxocyclobut-1-enolate.

Specific examples of cyanine-based fluorophores include, but are not limited to, 1-butyl-2-[5-(1-butyl-1,3-dihydro-3,3-dimethyl-2H-indol-2-ylidene)-penta-1,3-dienyl]-3,3-dimethyl-3eiti-indolium hexafluorophosphate, 1-butyl-2-[5-(1-butyl-3,3-dimethyl-1,3-dihydro-indol-2-ylidene)-3-chloro-penta-1,3-dienyl]-3,3-dimethyl-3H-indolium hexafluorophosphate and 3-ethyl-2-[5-(3-ethyl-3H-benzothiazol-2-ylidene)-penta-1,3-dienyl]-benzothiazol-3-ium iodide.

Specific examples of aromatic ring-based fluorophores include, but are not limited to, N,N-bis-(2,6-diisopropylphenyl)-1,6,7,12-(4-tert-butylphenoxy)-perylen-3,4,9,10-tetracarbonaciddiimide, N,N′-bis(2,6-diisopropylphenyl)-1,6,7,12-tetraphenoxyperylene-3,4:9,10-tetracarboxdiimide, N,N′-bis(2,6-diisopropylphenyl)perylene-3,4,9,10-bis(dicarbimide), 16,N,N′-bis(2,6-dimethylphenyl)perylene-3,4,9,10-tetracarboxylicdiimide, 4,4′-[(8,16-dihydro-8,16-dioxodibenzo[a,j]perylene-2,10-diyl)dioxy]dibutyric acid, 2,10-dihydroxy-dibenzo[a,j]perylene-8,16-dione, 2,10-bis(3-aminopropoxy)dibenzo[a,j]perylene-8,16-dione, 3,3′-[(8,16-dihydro-8,16-dioxodibenzo[a,j]perylen-2,10-diyl)dioxy]dipropylamine, 17-bis(octyloxy)anthra[9,1,2-cde-]benzo[rst]pentaphene-5-10-dione, octadecanoic acid, 5,10-dihydro-5,10-dioxoanthra[9,1,2-cde]benzo[rst]pentaphene-16,17-diylester, N,N′-di(nonyldecyl)-perylene-3,4,9,10-tetracarboxylic diimide and dihydroxydibenzanthrone.

Specific examples of oxazine-based fluorophores include, but are not limited to, Cresyl violet, Oxazine 170, EVOblue 30 and Nile Blue.

Specific examples of carbopyronine-based fluorophores include, but are not limited to, CARBOPYRONIN 149.

Specific examples of the pyrromethene-based fluorophores include, but are not limited to, PYRROMETHENE 650.

Specific examples of Alexa Fluor®-based fluorophores include, but are not limited to, Alexa Fluor 555, Alexa Fluor 568, Alexa Fluor 594, Alexa Fluor 610, Alexa Fluor 633, Alexa Fluor 635, Alexa Fluor 647, Alexa Fluor 660, Alexa Fluor 680, Alexa Fluor 700 and Alexa Fluor 750.

Specific examples of BODIPY®-based fluorophores include, but are not limited to BODIPY FL, BODIPY TMR, BODIPY 493/503, BODIPY 530/550, BODIPY 558/568, BODIPY 564/570, BODIPY 576/589, BODIPY 581/591, BODIPY 630/650 and BODIPY 650/665 (all of which are manufactured by Invitrogen).

Specific examples of Cy™-based fluorophores include, but are not limited to, Cy 3.5, Cy 5 and Cy 5.5.

Specific examples of DY™-based fluorophores include, but are not limited to, DY-590, DY-610, DY-615, DY-630, DY-631, DY-632, DY-633 and DY-634.

Specific examples of HiLyte™-based fluorophores include, but are not limited to, HiLyte™ 594 and HiLyteFluorTR.

Specific examples of DyLight™-based fluorophores include, but are not limited to, DyLight 594 and DyLight 633.

Specific examples of ATTO™-based fluorophores include, but are not limited to, ATTO 590, ATTO 610, ATTO 620, ATTO 633 and ATTO 655.

Specific examples of MFP™-based fluorophores include, but are not limited to, MFP 590 and MFP 631.

Examples of other fluorophores include, but are not limited to, C-phycocyanin, phycocyanin, APC (allophycocyanin), APC-XL and NorthernLights 637.

Further examples of fluorophores also include derivatives of the above-described dyes.

A fluorophore, as used herein, may be any one of the above-described fluorophores or derivatives thereof and may be covalently or non-covalently adhered on the surface of the solid-phase extraction (“SPE”) membrane. In some embodiments, the fluorophore may be covalently coupled to the solid phase extraction membrane and resulting fluorescence is detected directly on the SPE membrane. For example, the fluorophore may be covalently coupled to the SPE by a linker, including any linker to those skilled in the art or hereinafter developed. The linker may be formed by reaction of one or more functional groups on the SPE membrane and one or more functional groups on the fluorophore. Exemplary linking chemistry may include but is not limited to modifying the silica gel surface with amino-alkyl-trimethoxysilane, or amino-alkyl-triethoxysilane, to form an activated silica comprising an amine. Subsequently tethering the fluorophore via reaction with the amine moiety of the activated silica. In some embodiments, the fluorophore may be non-covalently adhered to the solid phase extraction membrane, such as via electromagnetic interactions including, but not limited to, electrostatic interactions, rr-effects interactions, hydrogen bonding, van der Waals forces, and/or hydrophobic interactions.

In some embodiments, the fluorophore may be selectively released and/or eluted from the SPE membrane and subsequently detected in solution. For example, the fluorophore may be covalently coupled to the membrane by a chemically cleavable linker that is cleaved in the presence of a cleavage agent. The fluorophore also may be non-covalently adhered to the SPE membrane by forces that may be disrupted by a selected elution medium, such as a high ionic strength solution, or a solution containing a composition that competes with the fluorophore for non-covalent binding with the SPE membrane.

### Negligible Depletion and Solid Phase Extraction

Negligible Depletion (“ND”), the equilibrium amount of analyte extracted by the SPE membrane, becomes dependent on the analyte concentration once the volume of solution flowing through the SPE membrane passes a threshold value. At this threshold volume, the extraction process has reached equilibrium and the concentration of sample existing in the membrane matches the concentration of sample entering into the membrane. This threshold volume is defined as the ND volume. Upon reaching the ND condition, the need to precisely control the volume of sample analyzed is eliminated. Under the condition of ND, the amount of measured fluorescence quenching can be readily correlated with the analyte concentration by means of a calibration curve, which normally follows the Langmuir adsorption model. This allows for convenient onsite analysis simply by passing through a large enough volume of water sample without worrying about the need to precisely control the volume of sample analyzed. Moreover, depending on the porosity and surface area of the SPE substrate used, high levels of analyte preconcentration can be achieved, which enables lower levels of detection.

To achieve ND, SPE membrane disks (and other embodiments) must be designed such that: (1) the effective volume of the solid capture surface or liquid bonded-phase is small compared to the typical sample volume; (2) the sample residence time within the SPME disk or capillary is long in relation to the relevant analyte extraction reaction; and (3) sample contact with inactive areas of the SPME disk or membrane is minimized or prevented. In order to meet these requirements, the flow rate of the sample must be carefully controlled to increase the sample residence time, thereby increasing analyte extraction efficiency. In membrane-based SPME, this can be accomplished by, for example, careful selection of pore sizes, volume capacities, and composition of both the membrane disk and the underlying wicking pad. In addition to ensuring sufficiently low flow rates through the SPE membranes in order to reach to binding equilibrium, conditions that facilitate ND can be achieved by proper selection of the capture antibody and the surface density at which the antibody is immobilized on the membrane.

“Solid phase extraction membranes” or “SPE membranes” as used herein may comprise a polymer, a copolymer, a resin, a filter, silica, or a combination thereof. In some embodiments, the polymer may be selected from a polytetrafluoroethylene, a polyvinylidene difluoride, a nitrocellulose, a cellulose acetate, a polyacrylonitrile, a polyimide, a polycarbonate, and a polypropylene, among other suitable polymers. In some embodiments, the SPE membrane comprises a polymer forming a porous polymeric aggregate or polymeric fibers with microparticles and/or nanoparticles embedded in the polymer. A “microparticle” or “nanoparticle” used herein refers to a plurality of particles that either adsorb or absorb liquids. In some embodiments the microparticle or nanoparticle may be formed of a silica, an activated carbon, a cation exchange resin, an anion exchange resin, a chelating agent, a polystyrenedivinylbenzene, or a reverse phase sulfonated polystyrenedivinylbenzene, among other suitable materials. In some embodiments, the microparticles or nanoparticles are C8 or C18 bonded silica. In some embodiments, the average particle size of the solid phase extraction membrane may be from about 0.5 μm to about 20 μm. In some embodiments, the average particle size may be from about 5 μm to about 15 μm. In some embodiments, the average particle size may be from 10 μm to about 15 μm. In some embodiments, the pore size of the SPE membrane is about 0.1 μm to about 10 μm. In some embodiments, the SPE membrane may be housed in a disk or other compatible apparatus. When the SPE membrane is housed in a disk, the diameter of the disk may range from about 5 mm to about 100 mm. In some embodiments, the SPE membrane may exist separate from a disk to allow for fluorescence imaging.

### Analyte Detection

As used herein, an “analyte” refers to any particle that is capable of dissolving in a solvent and is the subject of an analysis. In some embodiments, the solvent may be water. In some embodiments, an analyte may be a molecule comprising an amine such as a primary, secondary, or tertiary amine. An amine may be integrated into a carbocycle, a heterocycle, a heteroaryl, or an alkyl chain, among others. The amine also may be a substituent group attached to an alkyl chain, a carbocycle, an aryl, or a heteroaryl.

In some embodiments, the amine is an alkyl amine. Examples of an alkyl amine include, but are not limited to, methylamine, dimethylamine, ethylamine, diethylamine, 1-aminopentane, 3-amino pentane, N-butyl amine, sec-butylamine, tert-butylamine, dibutyl amine, N,N-diethylamine, diisopropylamine, N,N-diisopropyl amine, 1,3-dimethylbutylamine, dipropylamine, ethylmethylamine, hexylamine, isobutylamine, isopropylamine, methylhexanamine, neopentylamine, dimethylhexylamine, octylamine, tributyl amine, triethylamine, trioctylamine, tripropylamine, 2-aminoheptane.

In some embodiments, the amine is an alkanolamine. Examples of alkanolamines include, but are not limited to, methanolamine, ethanolamine, 2-amino-2-methyl-1-propanol, valinol, sphingosine, prolinol, tyrosinol, dimethylethanolamine, N-methylethanolamine, aminomethyl propanol, heptaminol, propanolamine, 2-amino-1-propanol, and epinephrine, norepinephrine.

In some embodiments, the amine is an aminoglycoside. Examples of aminoglycosides include, but are not limited to, kanamycin, streptomycin, neomycin, paromomycin, gentamicin, tobramycin, amikacin, netilmicin, neamine, sisomicin, lividomycin, dibekacin, isepamicin, framycin.

In some embodiments, the amine is a peptide. Examples of peptides include, but are not limited to, vancomycin and teicoplanin.

In some embodiments the amine is a sulfonamide. Non-limiting examples of sulfonamides include prontosil, sufanilamide, sulfadizene, sulfisoxazole, sulfacytine, sulfdoxine, sulfamerazine, sulfamethazine, sulfathiazole, sulfadimethoxine, sulfaphenzole sulfameter, sulfamoxole, sulfachlorpyridazine, sulfaethoxypyridazine, sulfaquinoxaline, chlorsulfaquinoxaline, sulfaisodimidine, sulfathiourea sulfaguanidine, sulfamethoxypyridazine, acetyl sulfisoxazole, sulfametrole, sulfanilamide, and sulfasalazine.

The sample comprising the analyte may be prepared experimentally or obtained from the natural environment. In some embodiments, the sample may be obtained from a river, lake, well, pond, stream, ocean, inlet, canal, loch, bay, fountain, sea, or a combination thereof. In other embodiments, the sample may be obtained from tap water, municipal water, municipal wastewater, industrial wastewater, run-off water, ballast water, water treatment water, agricultural water, or a combination of. A liquid sample comprising the analyte can be prepared by treating a solid sample with a liquid to dissolve an analyte. In some embodiments, the solid may be soil, sand, rock, or a combination thereof.

One embodiment described herein is a method for detecting an analyte in a liquid sample using a solid-phase extraction device that includes a solid-phase extraction membrane and a fluorophore adhered to the membrane, the method comprising: measuring fluorescence intensity of a surface on the solid-phase extraction membrane at an emission wavelength in the absence of the analyte; flowing the sample over the solid-phase extraction membrane; obtaining a negligible depletion condition for any analyte in the sample; measuring fluorescence intensity of the surface at an emission wavelength while the negligible depletion condition exists; and determining whether the analyte is present in the sample based on a change in the fluorescence. In one aspect, the fluorophore comprises a perylene, anthracene, oxazine, cyanine, pyrromethane, pyrene, rhodamine, pyyromethane difluoride, pyronine, or pentamethine. In another aspect, the fluorophore is non-covalently adhered to the solid-phase extraction membrane. In another aspect, the fluorophore is covalently adhered to the solid-phase extraction membrane. In another aspect, the analyte comprises an amine or an aniline. In another aspect, the analyte is an aminoglycoside, a peptide, a derivative thereof, or a metabolite thereof. In another aspect, the fluorophore is a perylene diimide fluorophore and the analyte is a compound comprising an amine. In another aspect, the perylene diimide fluorophore is N,N′-di(nonyldecyl)-perylene-3,4,9,10-tetracarboxylic diimide or a derivative thereof. In another aspect, the solid-phase extraction membrane is fabricated from a polymer, a copolymer, a resin, a filter, silica, or a combination thereof. In another aspect, the solid-phase extraction membrane is a polymer. In another aspect, the polymer comprises polytetrafluoroethylene. In another aspect, the solid-phase extraction membrane comprises silica modified with C18. In another aspect, the solid-phase extraction membrane has pores with diameters ranging from 0.1-10 μm. In another aspect, fluorescence is measured directly on the solid-phase extraction membrane. In another aspect, wherein fluorescence is measured after eluting the fluorophore from the solid phase extraction membrane. In another aspect, the method further comprises calculating the concentration of the analyte in the sample using a standard curve. In another aspect, the solid phase extraction membrane is incorporated into a disk. In another aspect, the disk has as diameter of 5 mm to 100 mm. In another aspect, measuring is performed with a fluorimeter or a fluorescence microscope.

It will be apparent to those of ordinary skill in the relevant art that suitable modifications and adaptations to the methods, processes, and applications described herein can be made without departing from the scope of any embodiments or aspects thereof. The methods provided are exemplary and are not intended to limit the scope of any of the specified embodiments. All of the various embodiments, aspects, and options disclosed herein can be combined in any variations or iterations. The scope of the methods and processes described herein include all actual or potential combinations of embodiments, aspects, options, examples, and preferences herein described. The exemplary methods described herein may substitute any component disclosed herein, or include any component disclosed elsewhere herein. Should the meaning of any terms in any of the patents or publications incorporated by reference conflict with the meaning of the terms used in this disclosure, the meanings of the terms or phrases in this disclosure are controlling. Furthermore, the foregoing discussion discloses and describes merely exemplary embodiments. All patents and publications cited herein are incorporated by reference herein for the specific teachings thereof.

Various embodiments and aspects of the inventions described herein are summarized by the following clauses:
Clause 1. A method for detecting an analyte in a liquid sample using a solid-phase extraction device that includes a solid-phase extraction membrane and a fluorophore adhered to the membrane, the method comprising:
   measuring fluorescence intensity of a surface on the solid-phase extraction membrane at an emission wavelength in the absence of the analyte;
   flowing the sample over the solid-phase extraction membrane;
   obtaining a negligible depletion condition for any analyte in the sample;
   measuring fluorescence intensity of the surface at an emission wavelength while the negligible depletion condition exists; and
   determining whether the analyte is present in the sample based on a change in the fluorescence.
Clause 2. The method of clause 1, wherein the fluorophore comprises a perylene, anthracene, oxazine, cyanine, pyrromethane, pyrene, rhodamine, pyyromethane difluoride, pyronine, or pentamethine.
Clause 3. The method of clauses 1 or 2, wherein the fluorophore is non-covalently adhered to the solid-phase extraction membrane.
Clause 4. The method of any one of clauses 1-3, wherein the fluorophore is covalently adhered to the solid-phase extraction membrane.
Clause 5. The method of any one of clauses 1-4, wherein the analyte comprises an amine or an aniline.
Clause 6. The method of any one of clauses 1-5, wherein the analyte is an aminoglycoside, a peptide, a derivative thereof, or a metabolite thereof.
Clause 7. The method of any one of clauses 1-6, wherein the fluorophore is a perylene diimide fluorophore and the analyte is a compound comprising an amine.
Clause 8. The method of any one of clauses 1-7, wherein the perylene diimide fluorophore is N,N′-di(nonyldecyl)-perylene-3,4,9,10-tetracarboxylic diimide or a derivative thereof.
Clause 9. The method of any one of clauses 1-8, wherein the solid-phase extraction membrane is fabricated from a polymer, a copolymer, a resin, a filter, silica, or a combination thereof.
Clause 10. The method of clause 9, wherein the solid-phase extraction membrane is a polymer.
Clause 11. The method of clause 10, wherein the polymer comprises polytetrafluoroethylene.
Clause 12. The method of clause 11, wherein the solid-phase extraction membrane comprises silica modified with C18.
Clause 13. The method of any one of clauses 1-12, wherein the solid-phase extraction membrane has pores with diameters ranging from 0.1-10 μm.
Clause 14. The method of any one of clauses 1-13, wherein fluorescence is measured directly on the solid-phase extraction membrane.
Clause 15. The method of any one of clauses 1-14, wherein fluorescence is measured after eluting the fluorophore from the solid phase extraction membrane.
Clause 16. The method of any one of clauses 1-15, further comprising calculating the concentration of the analyte in the sample using a standard curve.
Clause 17. The method of any one of clauses 1-16, wherein the solid phase extraction membrane is incorporated into a disk.
Clause 18. The method of clause 17, wherein the disk has as diameter of 5 mm to 100 mm.
Clause 19. The method of any one of clauses 1-18, wherein measuring is performed with a fluorimeter or a fluorescence microscope.

### EXAMPLES

### General Experimental Material and Methods

n-Propanol, kanamycin (C₁₈H₃₆N₄O₁₁, MW: 484.5 g/mol), and its sulfate salt, and acetic acid were purchased from Aladdin Reagent Co., Ltd (China). Aniline, NaCl, NaOH, Na₂SO₄, KH₂PO₄ were acquired from Macklin reagent Co., Ltd (China). All chemicals and reagents were of analytical grade quality, and used without further purification. Deionized (DI) water was prepared with an EPED-Smart-S2 water purification system (Nanjing Yipu Yida Technology Development Co., China). C_{9/9}-PDI was synthesized and purified following a protocol previously developed in our laboratory. See Balakrishnan et al., J. Am. Chem. Soc. 128: 7390-7398 (2006). Molecularly dispersed (i.e., non-aggregated) stock solutions (100 μM) of C_{9/9}-PDI was prepared in n-propanol. Stock solutions of aniline (10 mM) and kanamycin (100 μM), and all the spiked samples used in the test were prepared with DI water.

### Fabrication of Fluorophore Modified SPE Disks

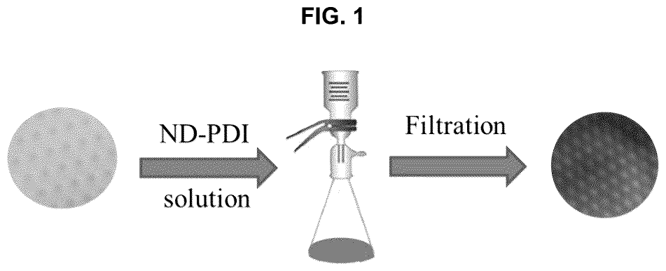

The fluorescent SPE disks were prepared by coating Empore™ SPE disks with C9/9-PDI. Empore™ disk consists of C18-modified silica particles (˜12 μm diameter) enmeshed in fibril-based polytetrafluoroethylene (PTFE) membranes (0.5 mm thickness) at 90% silica:10% PTFE (w/w). Surface coatings were prepared by passing 10 mL of C9/9-PDI solution (10 μM in n-propanol) through the disk by using the vacuum filtration setup (FIG. 1) at a flow rate of 0.08 mL/min for a total time of ˜12 min; a few higher flow rates were tested, e.g., 0.7 and 1 mL/min, but yielded visually heterogeneous precipitates on the outer surface of the membrane. The hydrophobic nature and chain structure of the C18-modified silica particles strongly adsorb the fluorophore by interdigitating with the C9 side chains of C9/9-PDI, dispersing it across the silica surface with little observable aggregation (vide infra). A few other C9/9-PDI concentrations and flow rates were tested, but the above condition resulted in the most homogeneous distribution of the fluorophore across the membrane by visual inspection.

### Instruments, Optical Measurements, and Data Analysis

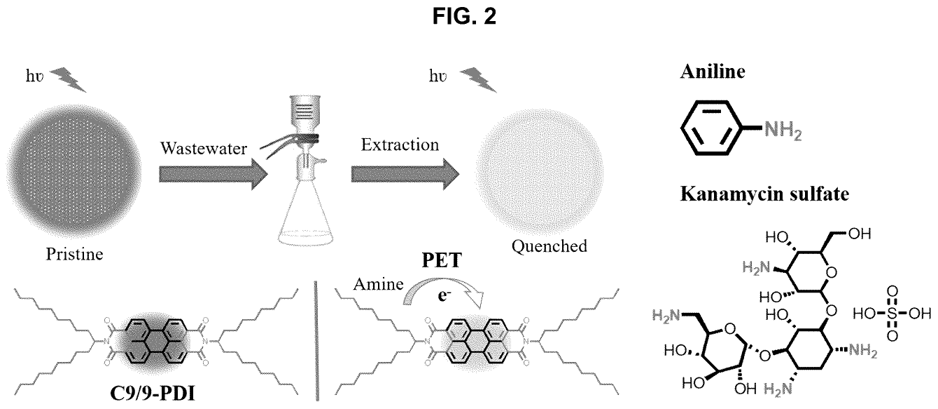

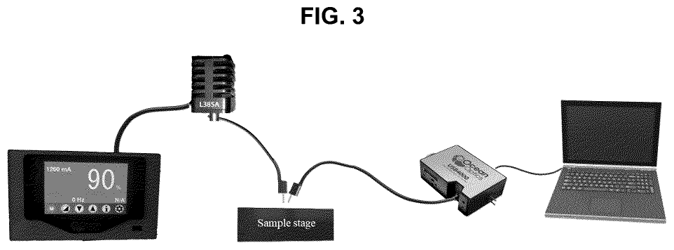

The UV-Vis absorption spectra of C9/9-PDI in n-propanol were measured using a Shimadzu spectrophotometer (UV-2600). The fluorescence spectra of the samples were acquired with an Edinburgh fluorometer (model FS5). A fluorescence microscope (OST-YW4000, Suzhou Oust Optical Instrument Co., Ltd.; China), set at a magnification of 400×(2 mm cylindrical spot size) was used to obtain fluorescence images of the samples. When used in F-SPE (FIG. 2), the fluorescence of the C9/9-PDI coated disk changes upon pulling aqueous amine-containing solutions through it by vacuum filtration. The changes in emission were measured using a field-portable fluorometer (USB4000-FL, Ocean Optics), which was equipped with a flexible optical fiber probe for optical excitation delivery and emission collection (FIG. 3). The angle of incidence for the optical fiber bundle was set at 45° with respect to the SPE disk surface. The excitation beam had a diameter of 2 mm. The data collected by the fiber optic spectrometer were uploaded to a spreadsheet on a computer for calculation of relative fluorescence intensities, construction of calibration and Langmuir isotherm plots, and estimation of LOD.

### F-SPE Disk Preparation and Spectral Characteristics

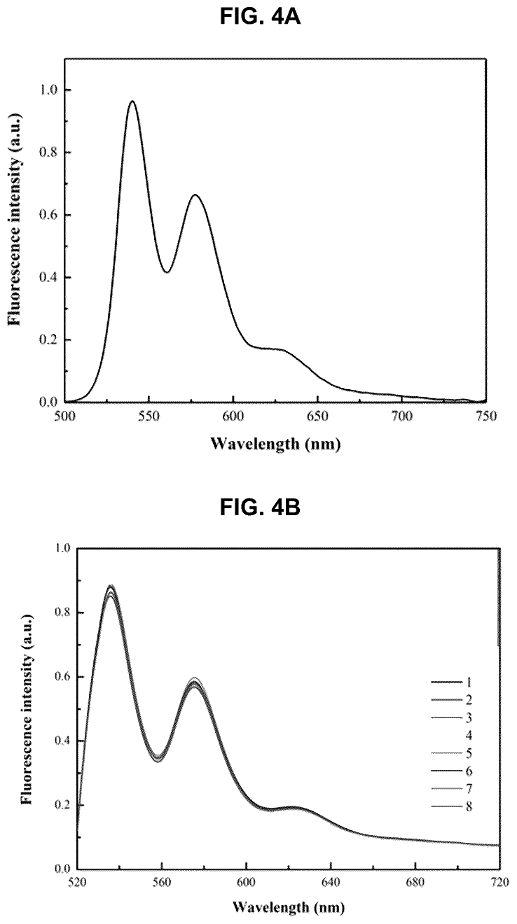

Spectra demonstrating the successful and reproducible impregnation of the fluorophore in the SPE disk (F-SPE) and the stability of impregnation in wash-off tests are given in FIG. 4A-C. FIG. 4A is the spectrum for C9/9-PDI dissolved in neat n-propanol (10 μM), which shows three distinct emission maxima (540, 578, and 630 nm), corresponding to the 0→0, 0→1 and 0→2 transitions, respectively. This spectral profile, which includes the relative differences in the strength of the three bands, is a signature for C9/9-PDI when it is molecularly dispersed (i.e., non-aggregated) in a solvent like n-propanol.

FIG. 4B presents fluorescence spectra for the SPE disk impregnated with C9/9-PDI measured after each rinse for a total of eight consecutive rinses (10 mL of DI water per rinse) using vacuum filtration. There are three points to draw from these spectra. First, the spectral profile for the impregnated fluorophore (emission maxima at 536, 578, and 626 nm) closely matches that for C9/9-PDI when dissolved in n-propanol. This shows the ability to load the disk with C9/9-PDI. Second, the strong similarities of the spectral profiles of the spectra for the solution and immobilized fluorophore indicate that the impregnated C9/9-PDI is well dispersed in a molecular state. This assessment is consistent with the visual uniformity of the green fluorescence intensity across the SPE disk shown in the inset to FIG. 4B. The molecular dispersion of impregnated C9/9-PDI is attributed to the strong intermolecular association/interdigitation of the C9 chains of C9/9-PDI and the C18 chains coated on the silica particles of the Empore™ disk. There is no detectable evidence for aggregated fluorophore, which otherwise has a single emission maximum at ˜620 nm across the same spectral region.

Third, the fluorescence spectra measured for the same disk across eight separate water washes shows a high level of consistency. This consistency documents the stability of immobilized C9/9-PDI when rinsed with water. The stability against water is also ascribed to the strong surface association of C9/9-PDI as mentioned above. Moreover, C9/9-PDI is insoluble in water, also making it difficult to be washed away by water. The small fluctuations of fluorescence intensity shown in FIG. 4B may be due to the rough surface of the disk, which may cause certain level of fluctuation for the emission measurement, especially via an optic fiber. In view of the observed measurement fluctuations, the averaged fluorescence intensity from 5 measurements at the same position on the substrate was used in all subsequent analyses.

The impregnation of C9/9-PDI is reproducible as shown by FIG. 4C. The fluorescence spectra measured for the five separately modified disks demonstrate a high level of consistency, e.g., the emission intensities of the 536 nm band for the five samples differ by only ˜4%. This low variability shows the reproducibility of impregnation. The high reproducibility may be attributed to the intrinsic homogeneous matrix of Empore™ disk and the effectiveness of the impregnation process facilitated by the strong surface association of C9/9-PDI. Highly repeatable fabrication of sensor materials is critical for translating a sensor technique to practical applications.

### Sampling Volume as Defined by the Principle of Negligible Depletion (ND)

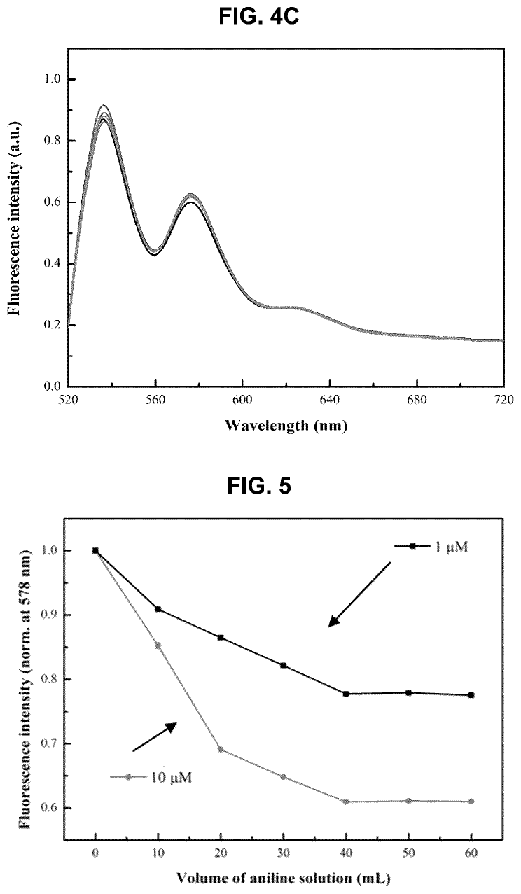

The results from measurements to determine the ND volume for aniline at two different aqueous solution concentrations (1 and 10 μM) with C9/9-PDI modified SPE disks are presented in FIG. 5. Sample volumes from 0 to 60 mL (10 mL increments) were tested. As is apparent, the fluorescence intensities for both aniline concentrations decrease as the volume of sample passed through the disk increases, reach limiting values at ˜40 mL, and remain effectively unchanged at larger sample volumes. These results indicate a ND volume of 40 mL for this combination of analyte and fluorophore-modified disk. The change in signal with volume of solution passed through the impregnated membrane also shows that the amount of fluorescence quenching for the 10 μM aniline solution is greater than that for the 1 μM solution. Both observations follow expectations for a well-behaved system operating under the condition of ND, i.e., the fluorescence quenching of the disk can be correlated with the equilibrium concentration of solution as defined by the Langmuir adsorption model and static quenching mechanism (vide infra).

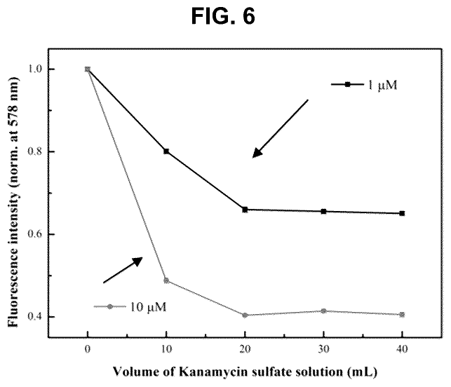

The same procedure was used to establish the ND volume for the analysis of kanamycin (1 and 10 μM aqueous solutions) using the same SPE disk modified with C9/9-PDI. These results are presented in FIG. 6. Similar to the results observed for aniline (FIG. 5), the strength of the fluorescence decreases with the volume of sample passed through the disk. In the case of kanamycin, however, the responses plateau at a sample volume of ˜20 mL, which is roughly half that required for aniline. The smaller value of ND volume found for kanamycin is attributed to the stronger intermolecular interaction with C9/9-PDI, for which the binding constant is about 2.5 times higher than that for aniline as deduced from the fluorescence quenching data (vide infra). The stronger affinity allows kanamycin to reach the equilibration (as probed by the fluorescence quenching) more effectively at lower ND volumes.

### Binding Equilibrium and Limit of Detection

When the volume of a sample passing through the SPE disk is at or above ND value, the uptake of analyte by the disk is at equilibrium, and the surface concentration of analytes (Cₛ) can be correlated with the solution concentration (C) following the classic Langmuir adsorption model,

$${C}_{s} = \frac{{C}_{s}^{0} KC}{1 + KC} \qquad ( 1 )$$

where Cₛ^{o} is the maximum surface concentration of analytes when all the adsorption sites are occupied, and K is the adsorption equilibrium constant. For a given SPE disk, Cₛ^{o} is a constant.

The surface adsorbed analytes will interact with the fluorophore embedded in the SPE disk, resulting in fluorescence quenching, which can be described as a typical static process in the format of Stern-Volmer equation,

$${C}_{s} = \frac{{C}_{s}^{0} KC}{1 + KC} \qquad ( 2 )$$

where I₀ is the fluorescence intensity measured in the absence of analytes, I is the intensity at a given surface concentration of analytes, and K′ is the binding constant between the analyte and fluorophore. Combining Eqs. (1) and (2) gives:

$$\frac{{I}_{0} - I}{{I}_{0}} = \frac{{C}_{s}^{0} {K}^{′} KC}{1 + ( 1 + {C}_{s}^{0} {K}^{′} ) KC} \qquad ( 3 )$$

Eq. 3 correlates the fluorescence quenching efficiency, defined as of (I₀−I)/I₀, directly with the concentration of analytes, thus enabling quantitative detection of analytes simply by measuring the fluorescence intensity change.

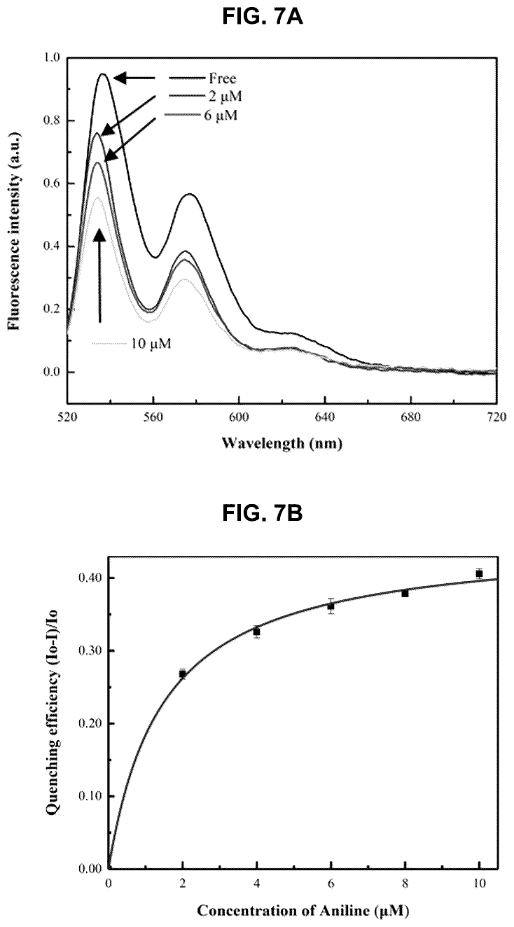

FIG. 7A-B presents the results and analysis of data from measuring the fluorescence of C9/9-PDI impregnated disks as a function of aniline concentration. FIG. 7A shows the expected decrease in fluorescence as the concentration of aniline increases. These spectra were used to generate the plot of (I₀−I)/I₀, as a function of aniline concentration presented in FIG. 7B, for which the fluorescence quenching data obtained can be fitted very well with Eq. (3) (with a R² value of 0.998), producing values of K (3.7±0.5×10¹ M⁻¹) and Cₛ^{o} K′ (0.83±0.04) for aniline. The fit can be used as a calibration curve to estimate the LOD, which is defined as the concentration of sample that corresponds to the blank signal plus three times its standard deviation.

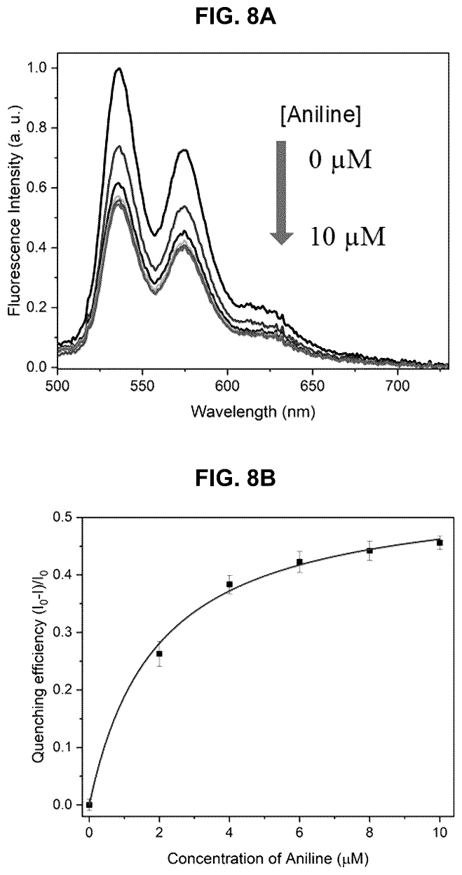

Accordingly, the LOD for aniline is projected to be 67 nM (˜6 ppb). The LOD thus obtained is lower than most of the values reported recently for many other fluorescence sensors, such as those based on metal-organic-framework (MOF), hydrogen-bonded organic framework, and modified BODIPY fluorophores. Even lower LOD (3 nM) was reported on a fluorescence turn-on sensor based on 2D coordination network constructed from hexacopper(I)-iodide clusters and cage-like amino phosphine blocks. However, the construction of this type of sensor materials requires tedious series of molecular and polymeric syntheses and intricate structural engineering. Summary comparisons of these sensors with our F-SPE sensor regarding LOD and other performance metrics can be found in Table 1. To further test the adaptability of F-SPE for analysis of real water samples, the same experiments shown in FIG. 7A-B were repeated for the samples prepared in tap water. The results obtained (FIG. 8A-B) demonstrate a strong consistency with respect to with 7A-B in terms of both fluorescence quenching measurement and fitting of data with Langmuir adsorption model (Eq. (3)), implying that the detection of amine with F-SPE is not significantly affected by the interferents like inorganic ions commonly present in tap water.

TABLE 1
Comparison of F-SPE with Fluorescent Sensors for Aniline Detection

| Sensor | Sensing | | Concentration | | | | |
|---|---|---|---|---|---|---|---|
| Material | Mechanism | Selectivity | Range | | LOD | | Ref. |
| Zn(II)-Tb(III) | Quenching | No response to common | 50-500 | μM | 5.2 | μM | 61 |
| heterometallic | | organic solvents, but no | | | | | |
| MOFs | | other amines tested | | | | | |
| Tb(III)-MOF | Quenching | Significant response to | 0-20 | nM | 83 | nM | 62 |
| | | other species like Pb²⁺, | | | | | |
| | | Cr₂O₇²⁻, B₄O₇²⁻ | | | | | |
| Hydrogen- | Enhancement | No response to aromatic | 30-300 | μM | 2.2 | μM | 63 |
| bonded organic | | interferents, but no other | | | | | |
| framework | | amines tested | | | | | |
| BODIPY | Quenching | Good selectivity against | 0.8-1.8 | μM | 242 | nM | 64 |
| fluorophore | | ethanol, phenol, acetone, | | | | | |
| | | formaldehyde, DMF, | | | | | |
| | | diethyl ether, ethyl | | | | | |
| | | acetate, and acetic acid | | | | | |
| Cu(I) | Turn-on | Good selectivity against | N/A only single | | 3 | nM | 65 |
| coordination | | other amines like 2,5- | concentration | | | | |
| polymer | | dichloroaniline, pyridine, | tested | | | | |
| | | 4,4′-bipyridyl, pyrazine, | | | | | |
| | | 2-aminopyridine, 2- | | | | | |
| | | aminopyrazine | | | | | |
| F-SPE | Quenching | Good selectivity against | 0.1-10 | μM | 67 | nM | This |
| | | common water pollutants | | | | | work |

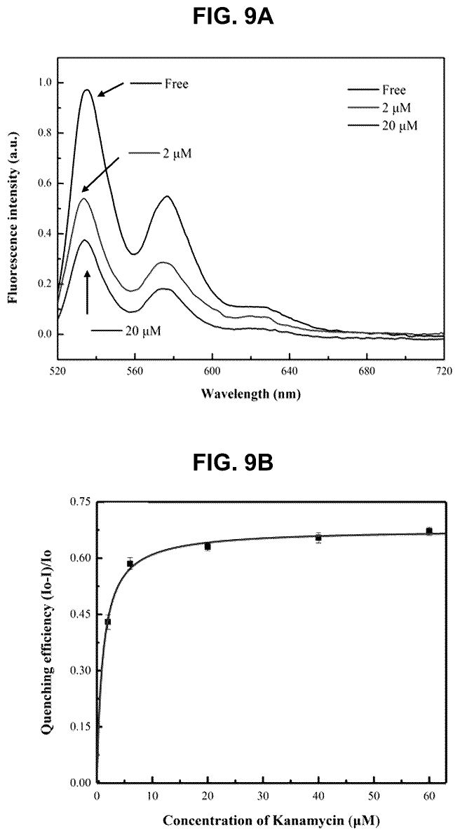

In completing our concept assessment of F-SPE, we tested its extensibility by analyzing water samples spiked with kanamycin. The results of these experiments are shown by the spectral data in FIG. 9A and fluorescence quenching dependence as a function of kanamycin concentration in FIG. 9B. As observed for aniline, the fluorescence quenching data obtained for kanamycin shown in FIG. 9B can also be fitted very well with Eq. (3) (with a R² value of 0.999), producing values of K (2.9±0.3×10⁵ M⁻¹) and Cₛ^{o} K′ (2.09±0.06) for kanamycin. The value of K obtained for kanamycin is slightly lower than that for aniline, which is consistent with its slightly higher hydrophobicity of aniline, as implied from the solubility of aniline and kanamycin in water, 35 and 50 g/L. Since Empore™ disk is composed of C18-modified silica gel embedded in PTFE matrix, the surface adsorption would be more preferred for hydrophobic molecule. The value of K′ obtained for kanamycin is about 2.5 times larger than that for aniline, indicating the stronger electron donor-acceptor binding interaction between kanamycin and C9/9-PDI, which is in turn consistent with the fact that there are four amine groups (acting as the electron donor) contained in kanamycin, while there is only one amine group in aniline.

Using the fitting data from FIG. 9B, we can estimate a LOD of 32 nM for kanamycin. This level obtained is comparable to or even better than that achieved with the sophisticated detection technologies developed previously for kanamycin, such as those based on surface plasmon resonance (SPR) spectroscopy, liquid chromatography coupled with pulsed electrochemical detection, liquid chromatography combined with SPE and tandem mass spectrometry. While even lower LODs (<10 nM) were reported for some other sensor systems, most of the sensors are either challenging for operation and control, or involve complicated material synthesis and engineering, thus not suited for immediate deployment in practical applications. To this regard, the F-SPE technique developed herein may find an easy practical path in the detection or screening of antibiotics and other drugs in water environments, taking combined advantages of the low LOD and simple process intrinsic of the ND concept of SPE. It is interesting that the extraction of both aniline and kanamycin reach saturation in fluorescence quenching as the concentration increases and that the saturated value is apparently dependent on the analytes. This can be interpreted as a limited condition of Eq. (3). When the solution concentration C increases to be sufficiently high, i.e., KC>>1, Eq. (3) can be approximated as Eq. (4),

$$\frac{{I}_{0} - I}{{I}_{0}} = \frac{{C}_{s}^{0} {K}^{′}}{{C}_{s}^{0} {K}^{′} + 1} \qquad ( 4 )$$

which implies that the fluorescence quenching efficiency will become saturated, reaching a plateau with the value determined only by the two constants, Cso and K′, when the concentration of analytes increases. Apparently, for a given SPE disk (with Cso fixed) the saturated quenching efficiency would depend solely on the intermolecular binding constant K′.

### Fluorescent Sensing and Selectivity Towards Amines

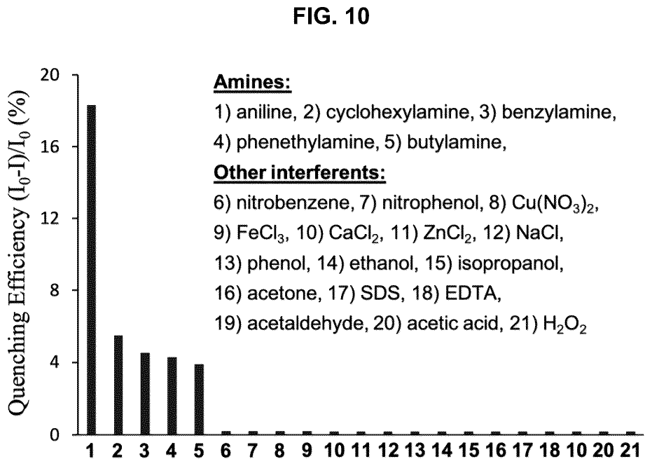

As discussed above, C9/9-PDI is a typical electron acceptor, and the fluorescence quenching is usually a result of interaction with an electron donor like aniline or other amines. In the water environment under ambient conditions, there are few molecules or ions that can compete effectively with amines functioning as an electron donor to enable fluorescence quenching of PDI. It is thus expected that the PDI sensor should demonstrate high selectivity towards amines vs. other common chemicals present in water environment such as alcohols, aldehydes, acetone, phenols, nitroaromatics, alkanes, surfactants, acetic acid, metal ions, anions, which can be considered as potential interferents to the F-SPE detection. To test such sensing selectivity, we performed the fluorescence quenching of PDI in ethanol solution by five different amines (aniline, benzylamine, phenethylamine, cyclohexylamine and butylamine) in comparison to 16 common interferents in water under the same condition (FIG. 10). All the five amines showed significant quenching, though the quenching efficiency of aniline was found about 4 times higher than that of the other four amines, which is mainly due to the aromatic nature of aniline that increases its strength as an electron donor. In contrast to the amines, all of the 16 interferents exhibit a minimal signal response (with quenching efficiency at or below 0.25%) when tested at the same concentration. This indicates a high level of selectivity by the PDI fluorophore towards amines as a class of analytes. Nonetheless, it is not possible for a single fluorophore to discriminate amines among a broad range of analogues due to their close structure and chemical properties. In general, a more realistic approach to achieving detection specificity would be incorporating different fluorophores onto a F-SPE disk patterned as an array, which will enable differential sensing. By coupling with automated machine learning, the differential sensing based on an array can usually provide high level discrimination power, even for the chemical analogues with very similar structure or properties, as evidenced in many other studies.

Described herein is an SPE-based detection technology, F-SPE, which includes a fluorescent sensor with solid phase extraction (SPE) surface. The F-SPE technology developed can detect trace level of aniline and kanamycin in water, with LOD down to 67 nM and 32 nM, respectively. The LODs obtained compare favorably to those reported for the fluorescence sensors based on different materials and sensing mechanisms. Coupling the intrinsic high sensitivity of fluorescent sensors to two unique features of SPE, i.e., the strong concentrative nature of SPE (usually with a concentrative factor of >1000) and the principle of negligible depletion (ND) eliminate the need to precisely control the volume of sample analyzed. Combining the high sensitivity, simplicity of use, and low cost, the F-SPE technology has great potential to be applied in detection of broad range of water pollutants by taking advantage of the extensibility of the design of fluorophores to target different types of chemicals.

What is claimed:

1. A method for detecting an analyte in a liquid sample using a solid-phase extraction device that includes a solid-phase extraction membrane and a fluorophore adhered to the membrane, the method comprising:
measuring fluorescence intensity of a surface on the solid-phase extraction membrane at an emission wavelength in the absence of the analyte;
flowing the sample over the solid-phase extraction membrane;
obtaining a negligible depletion condition for any analyte in the sample;
measuring fluorescence intensity of the surface at an emission wavelength while the negligible depletion condition exists; and
determining whether the analyte is present in the sample based on a change in the fluorescence.

2. The method of claim 1, wherein the fluorophore comprises a perylene, anthracene, oxazine, cyanine, pyrromethane, pyrene, rhodamine, pyyromethane difluoride, pyronine, or pentamethine.

3. The method of claim 1, wherein the fluorophore is non-covalently adhered to the solid-phase extraction membrane.

4. The method of claim 1, wherein the fluorophore is covalently adhered to the solid-phase extraction membrane.

5. The method of claim 1, wherein the analyte comprises an amine or an aniline.

6. The method of claim 1, wherein the analyte is an aminoglycoside, a peptide, a derivative thereof, or a metabolite thereof.

7. The method of claim 1, wherein the fluorophore is a perylene diimide fluorophore and the analyte is a compound comprising an amine.

8. The method of claim 7, wherein the perylene diimide fluorophore is N,N′-di(nonyldecyl)-perylene-3,4,9,10-tetracarboxylic diimide or a derivative thereof.

9. The method of claim 1, wherein the solid-phase extraction membrane is fabricated from a polymer, a copolymer, a resin, a filter, silica, or a combination thereof.

10. The method of claim 9, wherein the solid-phase extraction membrane is a polymer.

11. The method of claim 10, wherein the polymer comprises polytetrafluoroethylene.

12. The method of claim 11, wherein the solid-phase extraction membrane comprises silica modified with C18.

13. The method of claim 1, wherein the solid-phase extraction membrane has pores with diameters ranging from 0.1-10 μm.

14. The method of claim 1, wherein fluorescence is measured directly on the solid-phase extraction membrane.

15. The method of claim 1, wherein fluorescence is measured after eluting the fluorophore from the solid phase extraction membrane.

16. The method of claim 1, further comprising calculating the concentration of the analyte in the sample using a standard curve.

17. The method of claim 1, wherein the solid phase extraction membrane is incorporated into a disk.

18. The method of claim 17, wherein the disk has as diameter of 5 mm to 100 mm.

19. The method of claim 1, wherein measuring is performed with a fluorimeter or a fluorescence microscope.
